(19) United States
(12) Patent Application Publication
(10) Pub. No.: US 2007/0050051 A1
(43) Pub. Date: Mar. 1, 2007

(54) Cabinet with electronic lock

(76) Inventor: Ting-Wei Chang, Waipu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/507,587

(22) Filed: Aug. 22, 2006

(30) Foreign Application Priority Data
Aug. 23, 2005 (CN) 094128661

(51) Int. Cl. G05B 11/01

(52) U.S. Cl. 700/17

(57) ABSTRACT

A cabinet with an electronic lock primarily comprises: a cabinet body having a plurality of slide tracks to allow a plurality of drawers each having a retaining hook on the bottom thereof to be installed and slide thereon; a lock mechanism settled at the inside of the cabinet body having a vertical slide track which is upwards or downwards movable and, further comprises a plurality of retaining holes for receiving each retaining hook of the drawers and a working hole provided at the upper end of the slide track for receiving a pivotally horizontal shaft; and an electronic device having a control panel connected to a lock controller and a power supply through a circuit wherein the lock controller is connected to the vertical slide track by means of a couple element so that the vertical slide track can be driven to move upward or downward by the couple element under the impetus from lock controller that is dominated by the control panel having a programmable means of setting an on/off timer for precise and efficient management.

### BACKGROUND OF THE INVENTION

1. Technical Field

The present invention relates to a cabinet with an electronic lock and more particularly, to a tool cabinet with an electronic lock that allows a user to program a security code and on/off time.

2. Description of Related Art

A conventional cabinet may have a cabinet body with a plurality of drawers that can freely slide for accommodating tools or documents, and a locking mechanism for securing the drawers and protecting the user's privacy.

Said conventional lock may typically be a mechanical lock, thus, an exclusive key is indispensable for locking or unlocking the drawers. It is substantially inconvenient that whenever a drawer is to be used, the key keeper must unlock the drawers. Moreover, a key may be frequently reproduced as time goes on, rendering the lock ineffective in securing the cabinet. Consequently, drawer contents may be accessed by those who are unauthorized to do so.

Electronic devices are desirable for the advantages of lightweight, convenience and versatility. Therefore, a product, which combines an electronic element with a mechanical lock would be welcome and that is exactly what inspired the inventor of the present invention.

### SUMMARY OF THE INVENTION

The present invention has been accomplished under the circumstances in view. It is an object of the present invention to provide a cabinet equipped with an electronic lock wherein an electronic device relate to a locking mechanism for controlling the same so that the disclosed subject matter permits a user to program security codes and on/off time for the lock mechanism to facilitate precise and efficient management of the cabinet.

It is another object of the present invention to provide a cabinet equipped with an electronic lock wherein the locking mechanism is further connected to a forced unlocking assembly that permits a user to unlock the lock mechanism coercively.

To achieve these and other objects of the present invention, the cabinet with an electronic lock according to the present invention comprises:

a cabinet body, which comprises an internal space surrounded by five boards and a plate having plural opens toward a user for accommodating a plurality of drawers having retaining hooks on the bottoms to slide inward and outward thereon;

a lock mechanism settled at the inside of the cabinet body having at least one vertical sliding track which is upwards or downwards movable, and further comprising a plurality of retaining holes for receiving each retaining hook of the drawers and a working hole provided at the upper end of the slide track for receiving a pivotally horizontal shaft; and

an electronic device having a control panel connected to a lock controller and a power supply through a circuit wherein the lock controller is connected to the vertical slide tracks by means of a couple element so that the vertical slide tracks can be driven to move upward or downward by the couple element under the impetus from the lock controller that is dominated by the control panel.

### BRIEF DESCRIPTION OF THE DRAWINGS

FIG. 1 is a perspective view of the cabinet with an electronic lock according to the present invention.

FIG. 2 is a cross sectional transverse view showing the cabinet with an electronic lock under normality.

FIG. 3 is a schematic drawing showing the retaining hook retained in the vertical slide track.

FIG. 4 is another schematic drawing showing the retaining hook released from the retaining of the vertical slide track.

FIG. 5 is a partial perspective view illustrating the backup power supply applied to the disclosed subject matter.

FIG. 6 is a schematic drawing showing the drawers being unlocked with a forced unlocking assembly.

### DETAILED DESCRIPTION OF THE PREFERRED EMBODIMENT

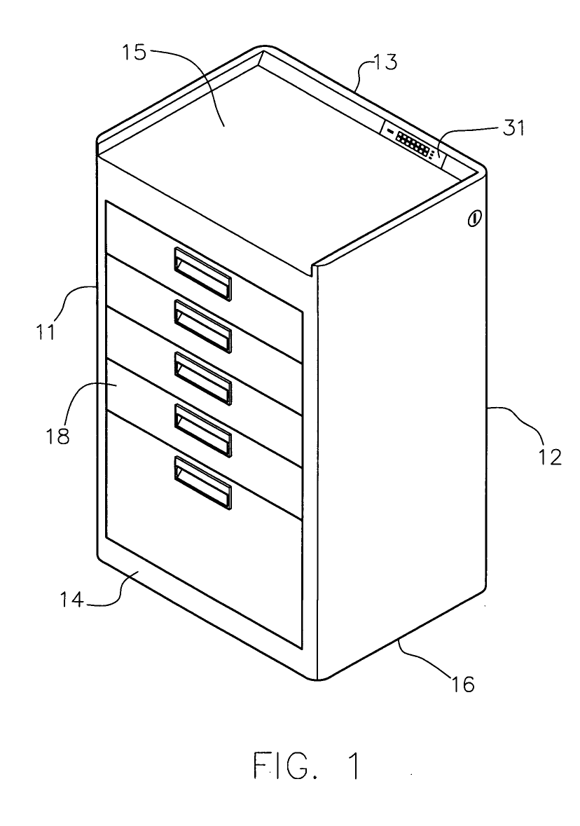

Please refer to FIGS. 1 to 6 for a preferred embodiment of the present invention. It is to be noted that the recited embodiment is for the purpose of illustration and not intended to limit the present invention with the discussed structure.

The cabinet with an electronic lock of the present invention primarily comprises:

a cabinet body 1, which comprises an internal space surrounded by five boards and a plate 14 having an opening toward the user, wherein the five boards are respectively a top board 15, a bottom board 16, a first board 11 and a second board 12 that are parallel to each other and a third board 13 that is parallel to the plate 14 and wherein a plurality of slide tracks 17 are disposed on the first board 11 and second board 12 to allow a plurality of drawers 18 each having a retaining hook 181 on the bottom thereof to be installed and slide thereon;

a lock mechanism 2 settled at the inside of the third board 13 having a vertical slide track 21 which is upwards or downwards movable and further comprises a plurality of retaining holes 211 for receiving the retaining hooks 181 of the drawers 18 and a working hole 212 provided at the upper end of the vertical slide track 21 for receiving a pivotally horizontal shaft 22; in the embodiment illustrated in the figures, the horizontal shaft 22 is composed of a bending portion 221 and two straight portions 222 respectively connected at each end of the bending portion 221 so that the bending portion 221 can be received by the working hole 212 and the horizontal shaft 22 is further connected to a forced unlocking assembly 23 at the other end opposite to the working hole 212-related end, wherein the forced unlocking assembly 23 may be a rotary switch that drives the horizontal shaft 22 to rotate; and

an electronic device 3 having a control panel 31, a lock controller 32 and a power supply 33, wherein, according the embodiment, the control panel 31 comprises an IC board that is equipped with the functions of programming security codes as well as on/off time and receiving signals and said control panel 31 communicates with the lock controller 32 and power supply 33 of the third board 13 by means of a circuit; and wherein, according the embodiment, the power supply 33 is composed of a primary power supply 331 and a backup power supply 332 that is plugged into the control panel 31, and the primary power supply 331 as well as the backup power supply 332 can be dry batteries or rechargeable batteries; and wherein, the lock controller 32 comprises an upwards or downwards movable protruding rod 321 which is connected to the vertical slide track 21 by means of a L-shaped couple element 34 so that the vertical slide track 21 can be driven to move upward or downward by the couple element 34 under the impetus from the protruding rod 321 of the lock controller 32 that is dominated by the control panel 31.

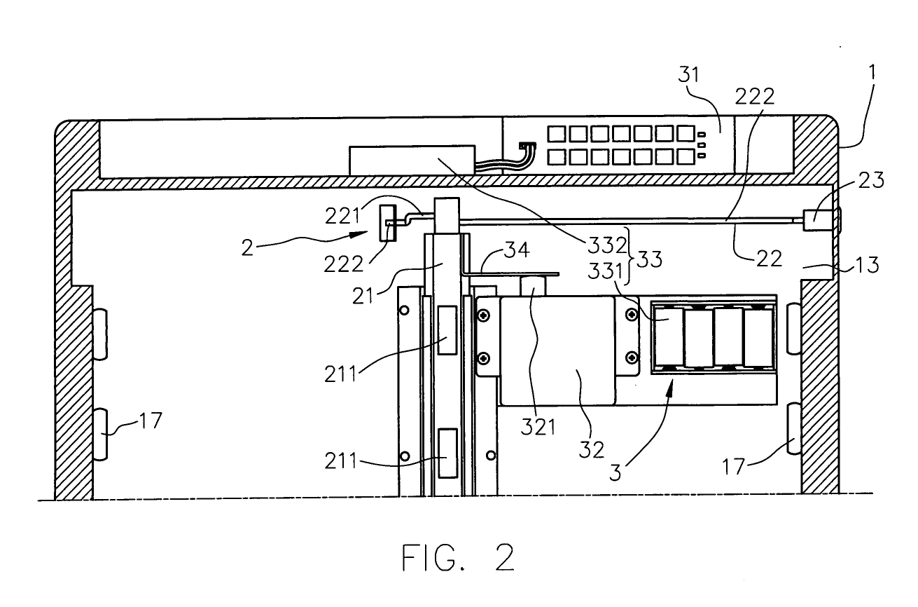

Under normality, as shown in FIG. 2, since each of the drawers 18 is shut inward the cabinet along the slide tracks 17 on the first and second board 11, 12, the retaining hooks 181 of the drawers 18 therefore passes through the retaining holes 211 and stays inside the vertical slide track 21. At this point, the protruding rod 321 of the lock controller 32 raises the couple element 34 upward so that the vertical slide track 21 keeps lifted withstanding gravity. Thus, the retaining hooks 181 of the drawers 18 can be free from retaining, and the drawers 18 can be moved inwards or outwards freely.

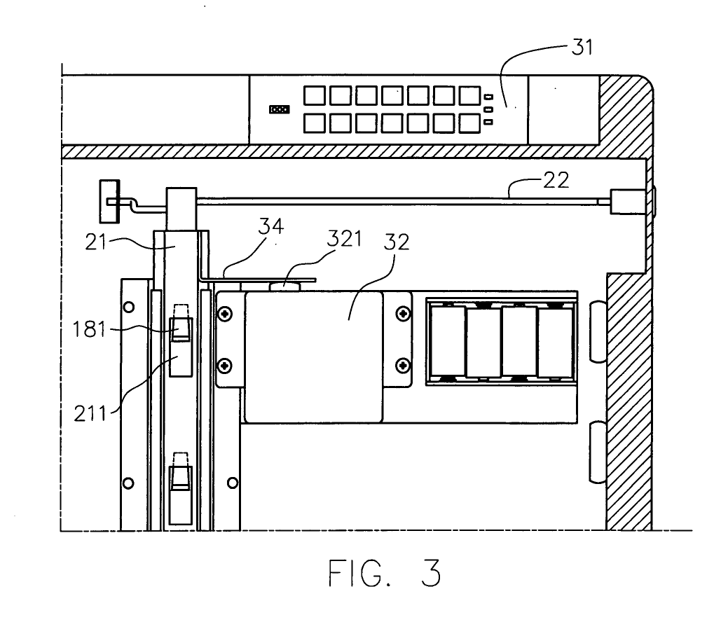

To lock the drawers 18, as shown in FIG. 3, a code is entered through the control panel 31 prompting the protruding rod 321 of the lock controller 32 downwards, and the vertical slide track 21 in turn drops under gravity. Consequently, the retaining hooks 181 that pass through the retaining holes 211 and stay inside the vertical slide track 21 are now retained by the vertical slide track 21 and lock the drawers 18.

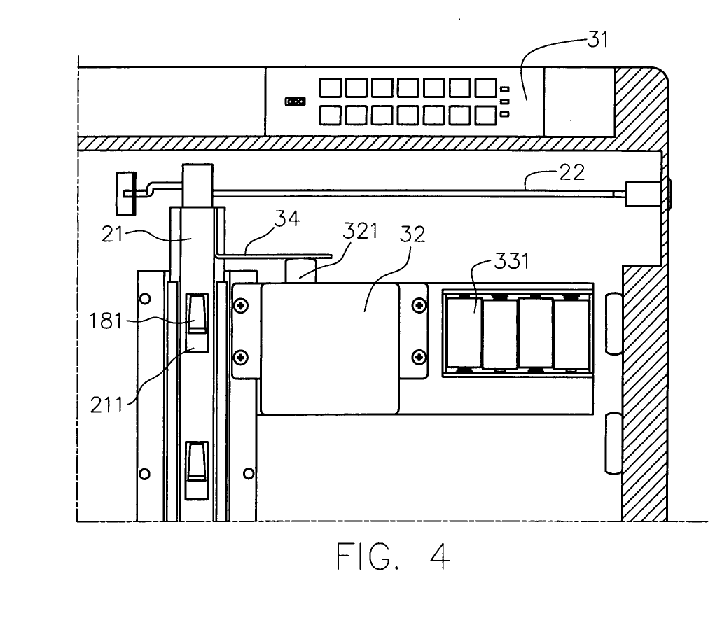

To unlock the drawers 18, as shown in FIG. 4, enter a specific code through the control panel 31 to protrude the protruding rod 321 of the lock controller 32 upward for lifting the couple element 34, and the vertical slide track 21 as well as the retaining holes 211 thereof are in turn raised upward. Consequently, the retaining hooks 181 are now released from the retaining holes 211 and thereupon, the drawers 18 recover unlocked.

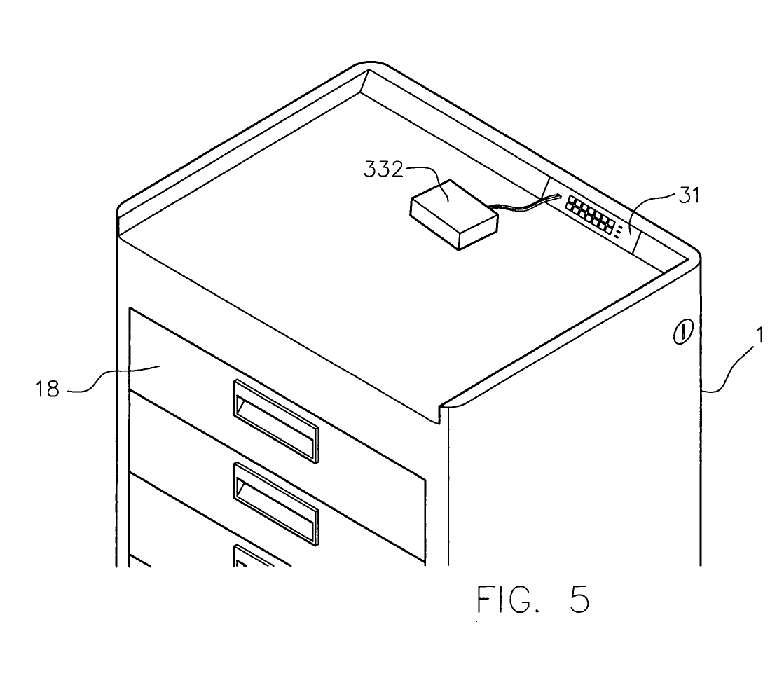

Further, as shown in FIG. 5, as the backup power supply 332 of a power supply 33 of the invention may be directly plugged into the control panel 31 to function, once the primary power supply 331 settled in the cabinet body 1 loses efficacy, said backup power supply 332 can immediately aid supplying power for proceeding locking or unlocking the drawers 18.

Besides, as the control panel 31 of the invention is a programmable IC board with on/off timer, a user is permitted to preset a time for locking/unlocking the drawers 18 via the control panel 31. And later, when the preset time is up, the control panel 31 can render the protruding rod 321 of the lock controller 32 moving upward or downward through the circuit. Thereby, the drawers 18 can be locked or unlocked according to the preset time.

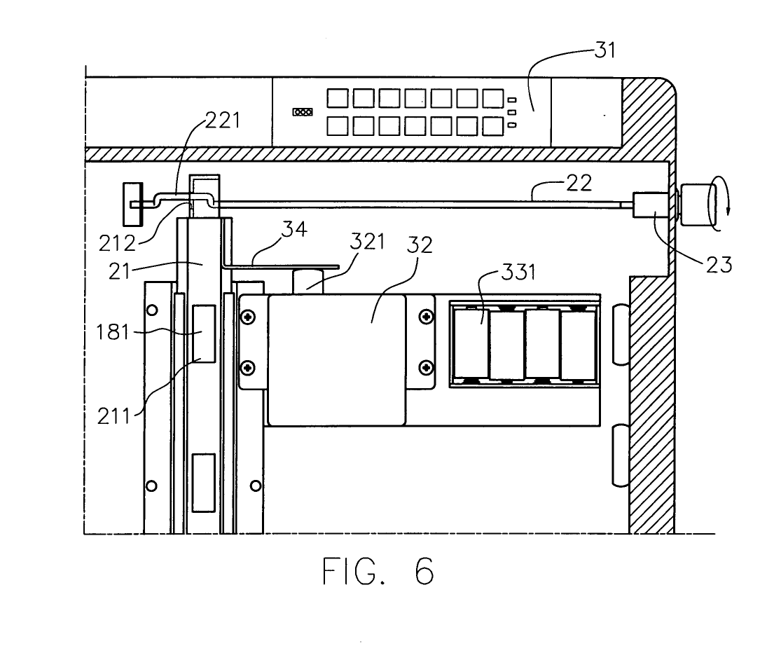

Additionally, in FIG. 6, since the horizontal shaft 22 is connected to the forced unlocking assembly 23 at the end opposite to the working hole 212-related end and the forced unlocking assembly 23 is a rotary switch that drives the horizontal shaft 22 to rotate; when the primary power supply 331 and backup power supply 332 both fail to supply power by any possibility, or when the lock controller 32 is damaged and incapable of operating the protruding rod 321 to lift the couple element 34, a user can still apply a key in the rotary switch to rotate the horizontal shaft 22. For the bending portion 221 of the horizontal shaft 22 is right received by the working hole 212 of the vertical slide track 21, the rotation of the horizontal shaft 22 conducts the rotation of the bending portion 221 and in turn drives the vertical slide track 21 moving upward and downward. As a result, the drawers 18 can be locked or unlocked accordingly.

In addition, the disclosed subject matter may be further equipped with a remote control that generates a particular signal to be received by the control panel 31 to operate the lock controller 32 for locking or unlocking the drawers 18.

What is claimed is:

1. A cabinet with an electronic lock primarily comprises:
a cabinet body, which comprises an internal space surrounded by five boards and a plate having a plural openings capable of accommodating a plurality of drawers having retaining hooks disposed underneath to slide inward and outward;
a lock mechanism settled at the inside of the cabinet body having a vertical slide track which is upwards or downwards movable and further comprises a plurality of retaining holes for receiving each retaining hook of the drawers and a working hole provided at the upper end of the slide track for receiving a pivotally horizontal shaft; and
an electronic device having a control panel connecting to a lock controller and a power supply through a circuit wherein the lock controller is connected to the vertical slide track by means of a couple element so that the vertical slide track can be driven to move upward or downward by the couple element under the impetus from lock controller that is dominated by the control panel.

2. The cabinet with an electronic lock of claim 1, wherein the horizontal shaft is connected to a forced unlocking assembly at the end opposite to the pivot-hole-related end, and wherein the forced unlocking assembly is a rotary switch that causes the horizontal shaft to rotate.

3. The cabinet with an electronic lock as claimed in claim 1, wherein the controlling panel comprises an IC board equipped with the functions of security code as well as time programming and receiving signals.

4. The cabinet with an electronic lock as claimed in claim 1, wherein the power supply for supplying power to the cabinet comprises a primary power supply and a backup power supply that is plugged into the controlling panel.

5. The cabinet with an electronic lock of claim 1, wherein the lock controller comprises a upwards or downwards movable protruding rod which is connected to the vertical slide track by means of a coupling element so that the vertical slide track can be driven to move upward or downward by the couple element under the impetus from lock controller that is dominated by the control panel.

6. The cabinet with an electronic lock of claim 1, wherein the primary power supply and backup power supply are dry batteries or rechargeable batteries.

7. The cabinet with an electronic lock of claim 1, wherein the couple element is generally L-shaped and connected with one end of the vertical slide track to be lifted by the protruding rod of the lock controller.

8. The cabinet with an electronic lock of claim 1, wherein the control panel further comprises a remote control that generates a particular signal to be received by the control panel to operate the lock controller for locking or unlocking the drawers.

9. The cabinet with an electronic lock of claim 1, wherein the boards are respectively a top board, a bottom board, a first board and a second board that are parallel to each other and a third board that is parallel to the plate and wherein a plurality of slide tracks are disposed on the first board and second board to allow a plurality of drawers each having a retaining hook on the bottom thereof to be installed and slide thereon; and wherein the vertical slide track is disposed on the third board, and wherein the lock controller and power supply are installed on the third board to be controlled by the control panel through a circuit for conducting the vertical slide track to move upward and downward.
